(19) United States
(12) Patent Application Publication
(10) Pub. No.: US 2009/0227332 A1
(43) Pub. Date: Sep. 10, 2009

(54) GAMING MACHINE THAT PERFORMS REARRANGING OF IDENTICAL SYMBOLS CONSECUTIVELY IN PREDETERMINED DIRECTION FROM DISPLAY POSITION OF SPECIAL SYMBOL

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/233,938

(22) Filed: Sep. 19, 2008

Related U.S. Application Data
(60) Provisional application No. 61/033,994, filed on Mar. 5, 2008.

(51) Int. Cl. A63F 13/00

(52) U.S. Cl. 463/20

(57) ABSTRACT

A gaming machine 13 rearranges symbols on a liquid crystal display 30, determines whether a symbol to which a predetermined image is added is rearranged, upon determining that the symbol is not rearranged, providing an award corresponding to the number of the same type of symbols aligned in consecutive blocks on a single line in a symbol display block in a matrix, and, upon determining that the symbol is rearranged, rearranging again the symbols rearranged so as to align the symbol and the same type of symbols as the symbol to which a predetermined image is added in consecutive blocks on a single line in symbol display blocks in a matrix, and providing an award corresponding to the number of the symbol and the same type of symbols as the symbol to which a predetermined image is added aligned in consecutive blocks.

### CROSS REFERENCE TO RELATED APPLICATIONS

This application claims benefit of U.S. Provisional Application No. 61/033,994, filed Mar. 5, 2008, the entire contents of which are incorporated herein by reference.

### BACKGROUND OF THE INVENTION

1. Field of the Invention

The present invention relates to a gaming machine which rearranges identical symbols consecutively in a predetermined direction from a display position of a special symbol.

2. Related Art

Conventionally, in slot machines, a game is started when a player bets a certain amount of credits. Then, a plurality of reels on which a plurality of symbols are depicted start to rotate, and are stopped after a predetermined lapse of time. As a result, a certain award is provided to the player based on a symbol combination which is displayed statically. U.S. Pat. No. 6,517,433 describes that an award is provided corresponding to a predetermined number of symbols rearranged on a winning line.

In addition, in slot games, it may occur that identical symbols are rearranged to be adjacent consecutively. However, in U.S. Pat. No. 6,517,433, even if identical symbols are rearranged adjacent contiguously, an award is not provided to a player. In addition, even if an award is supposed to be provided to a player corresponding to the number of symbols rearranged adjacent contiguously, a game is still monotonous as it was before if symbols are not rearranged adjacent contiguously.

The present invention provides a gaming machine with novel entertainment properties which can attract players by means of providing a special symbol, and, even if identical symbols are not rearranged to be adjacent consecutively, but the special symbol is rearranged, rearranging identical symbols including the special symbol so as to be adjacent consecutively.

### SUMMARY OF THE INVENTION

In an aspect of the present invention, a gaming machine is provided, in which includes: a display for variably displaying each of a plurality of symbol groups; and a controller for executing the following operations of: (a) generating a random number and starting a game; (b) determining a symbol to be rearranged on the display corresponding to the random number generated; (c) variably displaying each of the plurality of symbol groups on the display; (d) rearranging the symbol determined; (e) providing a first award corresponding to a number of identical type of symbols rearranged in the processing of (d); (f) determining whether a symbol to which a predetermined image is added is rearranged among the rearranged symbols in the processing of (d); (g) upon determining that the symbol to which a predetermined image is added is not rearranged in the processing of (f), providing a second award corresponding to the number of the identical type of symbols aligned in consecutive blocks on a single line in a symbol display block in a matrix in the processing of (d); (h) upon determining that the symbol to which a predetermined image is added is rearranged in the processing of (f), rearranging again the symbols rearranged in the processing of (d) so as to align the symbol to which a predetermined image is added and the identical type of symbols as the symbol to which a predetermined image is added in consecutive blocks on a single line in a symbol display block in a matrix in the processing of (d), and providing a second award corresponding to the number of the symbol to which a predetermined image is added and the identical type of symbols as the symbol to which a predetermined image is added aligned in consecutive blocks.

In another aspect of the present invention, a gaming machine is provided, in which includes: a display for variably displaying each of a plurality of symbol groups; and a controller for executing the following operations of: (a) generating a random number and starting a game; (b) determining a symbol to be rearranged on the display corresponding to the random number generated; (c) variably displaying each of the plurality of symbol groups on the display; (d) rearranging the symbol determined; (e) providing a first award corresponding to the number of identical type of symbols rearranged in the processing of (d); (f) determining whether a special symbol to which a predetermined image is added is rearranged among the symbols rearranged in the processing of (d); (g) upon determining that the special symbol to which a predetermined image is added is not rearranged in the processing of (f), providing a second award corresponding to a number of the special symbols aligned in consecutive blocks on a single line in a symbol display block in a matrix in the processing of (d); (h) upon determining that the special symbol to which a predetermined image is added is rearranged in the processing of (f), rearranging again the symbols rearranged in the processing of (d) so as to align the special symbol to which a predetermined image is added and the identical type of special symbols as the special symbol to which a predetermined image is added in consecutive blocks on a single line in symbol display blocks in a matrix in the processing of (d), and providing a second award corresponding to the number of the special symbol to which a predetermined image is added and the identical type of special symbols as the special symbol to which a predetermined image is added lined in consecutive blocks.

### BRIEF DESCRIPTION OF THE DRAWINGS

FIG. 1 is a flowchart showing processing in a game executed in a gaming machine according to an embodiment of the present invention;

FIG. 2 is a perspective view showing the external appearance of the gaming machine according to the embodiment of the present invention;

FIG. 3 is an enlarged front view showing a display area of the gaming machine according to the embodiment of the present invention;

FIG. 4 is a block diagram of a controller of the gaming machine according to the embodiment of the present invention;

FIG. 5 is a block diagram of a display/input controller of the gaming machine according to the embodiment of the present invention;

FIG. 6 is a flowchart showing basic game processing executed in the gaming machine according to the embodiment of the present invention;

FIG. 7 is a flowchart of adjacency awarding processing executed in the gaming machine according to the embodiment of the present invention; and

FIGS. 8 to 10 are examples of display screens displaying rendered effects executed in the gaming machine according to the embodiment of the present invention.

### DETAILED DESCRIPTION OF THE INVENTION

An embodiment of the present invention is described below with reference to the accompanying drawings.

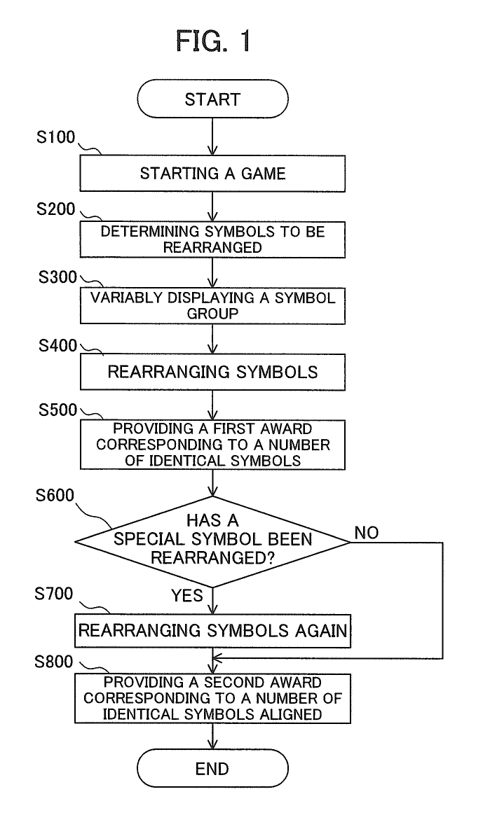

As shown in FIG. 1, the CPU 106 starts a game (Step S100), determines symbols to be rearranged (Step S200), variably displays a symbol group (Step S300), rearranges symbols (Step S400), and provides a first award corresponding to a number of the same type of symbols (Step S500). Next, the CPU 106 determines whether a special symbol (Mag symbol), to which a predetermined image is added, has been rearranged (Step S600), when the special symbol is arranged, rearranges symbols again so that the special symbol and the same type of symbols as the special symbol are lined in consecutive blocks on a single line (Step S700), and provides a second award corresponding to the number of the same type of symbols thus aligned (Step S800). The abovementioned processing for providing a second award corresponding to the number of the same type of symbols aligned is performed even when the special symbol is not arranged.

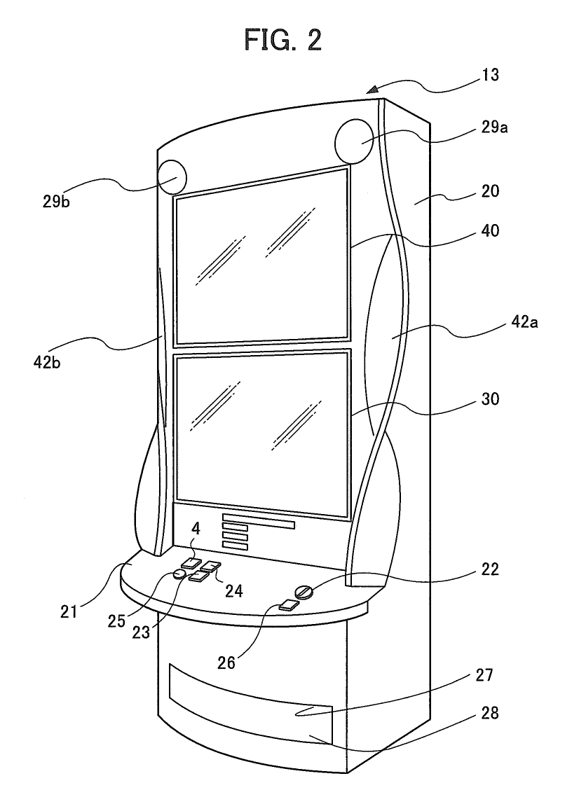

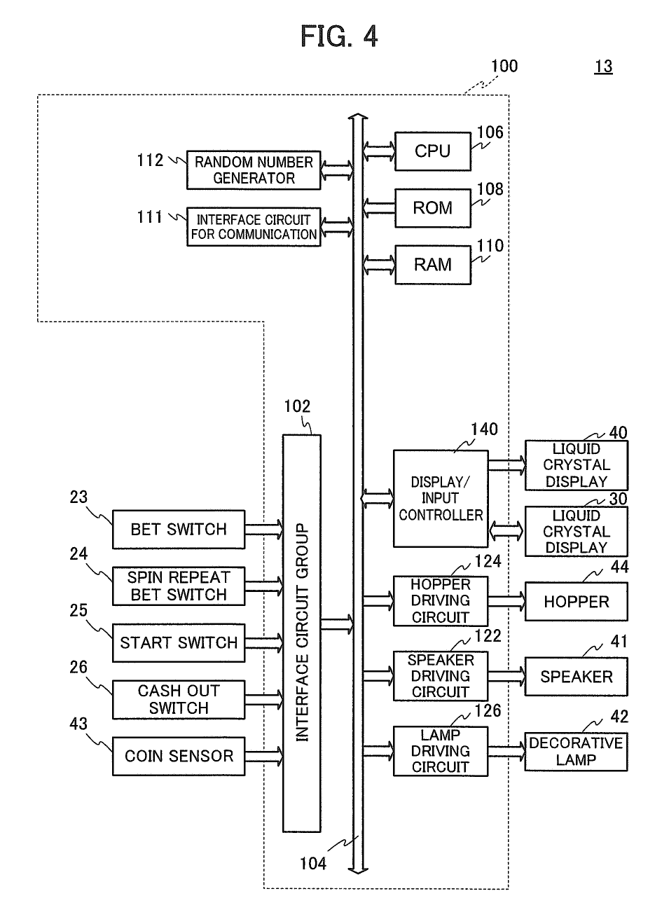

FIG. 2 is a perspective view showing the gaming machine 13 according to an embodiment of the present invention. The gaming machine 13 includes a cabinet 20. The cabinet 20 has a structure in which the face facing the player is open. The cabinet 20 contains various components including a game controller 100 (see FIG. 4) for electrically controlling the gaming machine 13, and a hopper 44 (see FIG. 4) for controlling the insertion, storage, and payout of coins (one of game media), and the like. The game medium is not restricted to coins. In addition, examples of such game media include medals, tokens, electronic money or electronic value information (credits) having the same value.

The liquid crystal display 30 is installed substantially in the middle of the front face of the cabinet 20, and the liquid crystal display 40 is installed in an upper side of the cabinet 20.

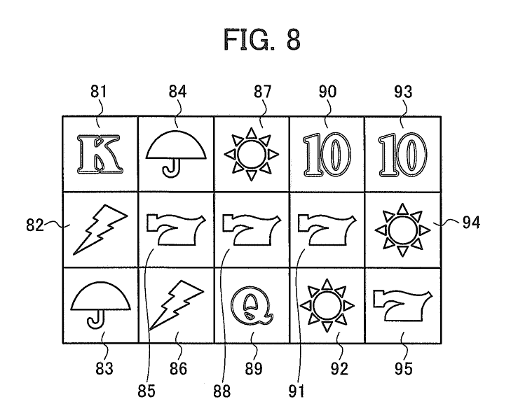

The liquid crystal display 30 realizes a display device for displaying a variety of images related to the game including rendered images and the like. Such a configuration allows the player to advance the game while visually confirming various kinds of images displayed on the aforementioned liquid crystal display 30. In such a game, the liquid crystal display 30 displays a slot game as shown in FIGS. 8 to 10.

The gaming machine 13 includes video reels (a group of symbol images), and fifteen virtual reels can be displayed on the liquid crystal display 30. It should be noted that the term “video reel” as used here represents a mechanism for displaying a reel on the liquid crystal display 30 in the form of an image.

The other liquid crystal display 40 above the liquid crystal display 30 is a display functioning as a sub display for displaying the rules of the game, demonstration screens, and the like.

Sound transmission openings 29a and 29b, through which sound effects emitted from a speaker 41 (see FIG. 4) contained inside the cabinet 20 are propagated outside the cabinet 20, are disposed on the upper right and left sides of the liquid crystal display 40, respectively. The sound transmission openings 29a and 29b generate sound effects and the like in accordance with the progress of the game. In addition, decorative lamps 42a and 42b are disposed on the right and left sides substantially in the middle of the gaming machine 13, respectively. The decorative lamps 42a and 42b emit light in accordance with the progress of the game.

The gaming machine 13 includes a substantially horizontal operation portion 21 below the liquid crystal display 30. Disposed on the right side of the operation portion 21 is a coin insertion slot 22 through which a number of coins are inserted into the gaming machine 13. On the other hand, the components provided to the left side of the operation portion 21 include: a BET switch 23 that allows the player to select the number of coins, which serves as a gaming medium to be bet; and a spin repeat bet switch 24 that allows the player to play another game without changing the number of coins bet in the previous game. Such an arrangement allows the player to set the number of coins to be bet by performing a pushing operation on either the BET switch 23 or the spin repeat bet switch 24.

In the operation portion 21, a start switch 25 for accepting for each game the player's operation for starting a game is disposed on the left side of the bet switch 23. Upon performing a pushing operation on either the start switch 215 or the spin repeat bet switch 24, which serve as a trigger to start the game, an image in which the aforementioned fifteen video reels start to rotate is displayed.

A cash out switch 26 is provided near the coin insertion opening 22 on the operation unit 21. Upon the player pushing the cash out switch 26, the inserted coins are paid out from a coin payout opening 27 provided at a lower portion of the front face. The coins thus paid out are retained in a coin tray 28.

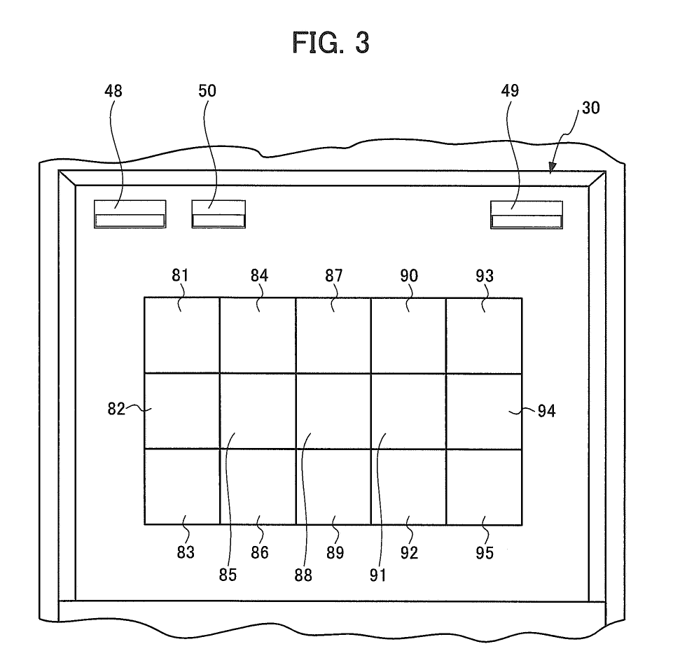

FIG. 3 shows an enlargement of a display area of the gaming machine 13. As shown in FIG. 3, the gaming machine 13 has symbol display areas 81 to 95 arranged in a matrix of 3 rows by 5 columns. The symbol display areas are also called as symbol display blocks or symbol display position. The fifteen video reels corresponds to each of the symbol display areas 81 to 95.

The game available in the present embodiment is a game in which an award is provided to a player corresponding to the number of identical symbols rearranged on the symbol display areas 81 to 95. The number of identical symbols targeted for awarding can be defined arbitrarily such as three or more symbols, and the like.

It is arranged so that a payout number display portion 48, a BET number display portion 50, and a credit number display portion 49 can be displayed in this order from the left side on the upper portion of the liquid crystal display 30. The payout number display portion 48 is a component for displaying the amount of the coins paid out when no less than a predetermined number of identical symbols for providing an award are rearranged and displayed on the liquid crystal display 30. The credit number display portion 49 displays the credit number of coins stored in the gaming machine 13. The BET number display portion 50 is a component for displaying the bet amount, which is the number of coins bet.

FIG. 4 is a block diagram showing the electrical configuration of the game controller 100 of the gaming machine 13. Referring to FIG. 4, the game controller 100 of the gaming machine 13 is a microcomputer and provided with an interface circuit group 102, an input/output bus 104, CPU 106, ROM 108, RAM 110, an interface circuit 111 for communication, a random number generator 112, a speaker driving circuit 122, a hopper driving circuit 124, a lamp driving circuit 126, and a display/input controller 140.

The interface circuit group 102 is electrically connected with the input/output bus 104, which carries out input and output of data signals or address signals for the CPU 106.

The start switch 25 is electrically connected with the interface circuit group 102. In the interface circuit group 102, a start signal generated by the start switch 25 is converted into a predetermined form of signal to be supplied to the input/output bus 104.

Furthermore, the BET switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also electrically connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

Upon accepting the start operation of a game through the start switch 25, the CPU 106 reads a game program to execute the game. The game program is programmed as follows. That is, a display for starting the scrolling of the symbols on the fifteen video reels is made on each of the symbol display areas 81 to 95 on the liquid crystal display 30 via the display/input controller 140. Thereafter, a display for stopping the fifteen video reels is made to rearrange the fifteen video reels. In a case where no less than a predetermined number of identical symbols among all of the symbols which are stopped in each reel are rearranged, coins corresponding to the number of identical symbols rearranged are paid out.

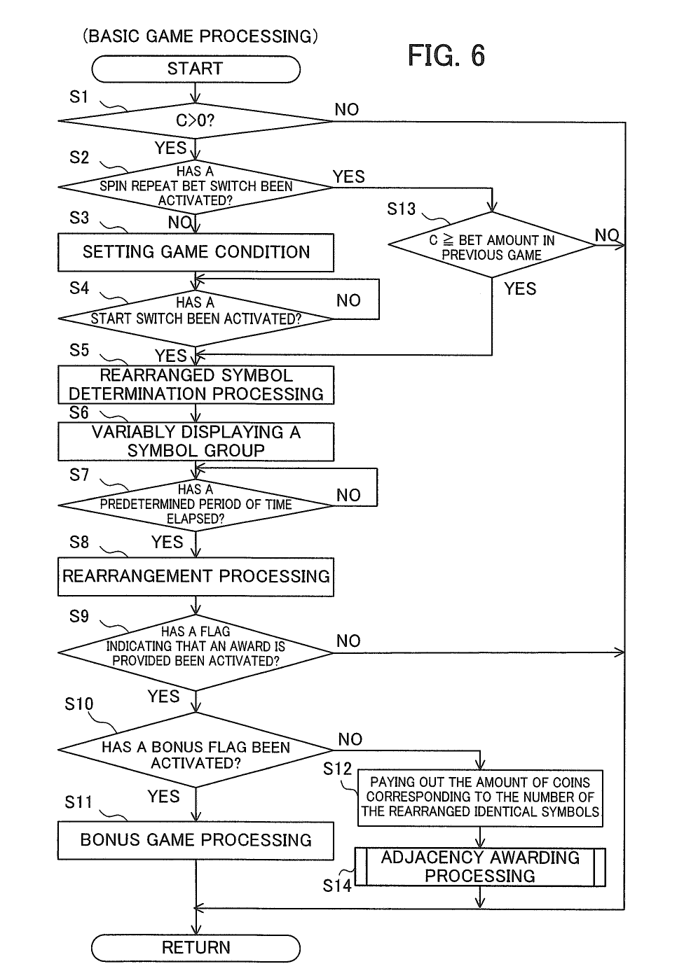

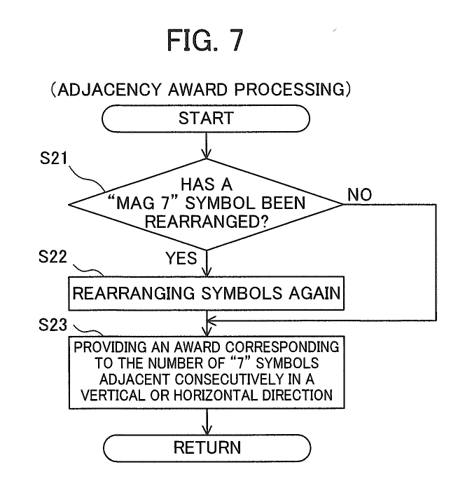

The ROM 108 stores a control program for governing and controlling the gaming machine 13, a program for executing routines as shown in FIGS. 6 and 7 (hereinafter referred to as a “routine execution program”), and initial data for executing the control program, and various data tables used in determination processes. The routine execution program includes the abovementioned game program. The RAM 110 temporarily stores flags, variables, etc., used for the aforementioned control program.

The game program includes a rearranged symbol determination program. The rearranged symbol determination program is used for determining fifteen symbols to be rearranged on the symbol display areas 81 to 95. The rearranged symbol determination program includes symbol weighted data that corresponds to each of multiple types of payout rates (e.g., 80%, 84%, and 88%). The symbol weighted data is data for each of the five video reels 3A to 3E, and indicates the correspondence between each symbol and one or multiple random numbers in a predetermined number range (0 to 65535). The payout rate is determined based upon the payout rate setting data stored in the ROM 108. The determination of rearranged symbols is performed based upon the symbol weighted data that corresponds to the payout rate.

Furthermore, a communication interface circuit 111 is connected to the input/output bus 104. The communication interface circuit 111 is a circuit for communicating with the central controller 11, etc. via the network including various types of networks such as a LAN.

The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The speaker drive circuit 122 for driving the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper drive circuit 124 for driving the hopper 44 is also electrically connected with the input/output bus 104. Upon receiving a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credit by inserting the card into the gaming machine 13.

The lamp driving circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. Thus, the decorative lamps 42a and 42b blink and the like.

The display/input controller 140 is connected to the input/output controller 140. The CPU 106 creates an image display command corresponding to the state and results of the game, and outputs the image display command thus created to the display/input controller 140 via the input/output bus 104. Upon receiving the image display command input from the CPU 106, the display/input controller 140 creates a driving signal for driving the liquid crystal display 30 and the liquid crystal display 40 according to the image display command thus input, and outputs the driving signal thus created to the liquid crystal display 30 and the liquid crystal display 40. As a result, a predetermined image is displayed on the liquid crystal display 30 and the liquid crystal display 40. The display/input controller 140 transmits the signal input through the touch panel 32 provided on the liquid crystal display 30 to the CPU 106 via the input/output bus 104 in the form of an input signal. In addition, the image display command includes commands corresponding to the payout number display portion 48, the credit number display portion 49, and the BET number display portion 50.

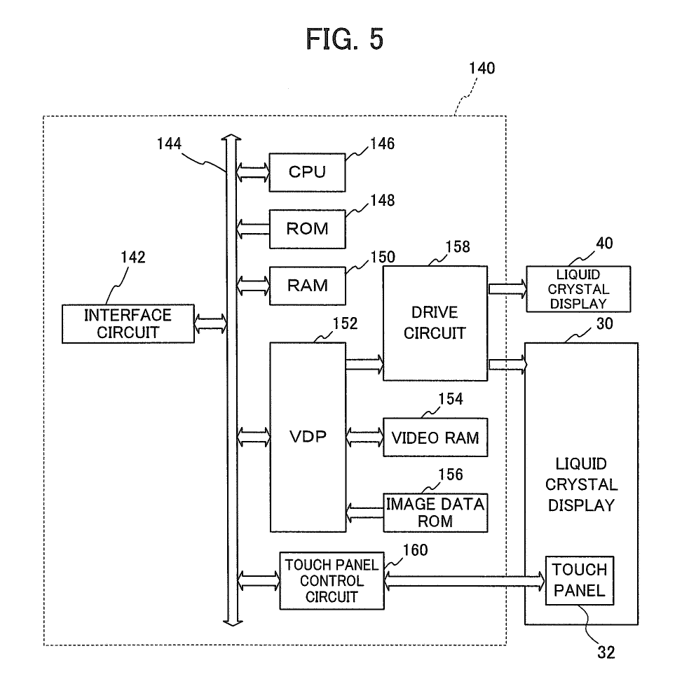

FIG. 5 is a block diagram showing the electrical configuration of the display/input controller 140 of the gaming machine 13. The display/input controller 140 is a sub microcomputer which performs image display processing and the control of input from a touch panel 32, and which has an interface circuit 142, an input/output bus 144, CPU 146, ROM 148, RAM 150, VDP 152, video RAM 154, image data ROM 156, a drive circuit 158, and a touch panel control circuit 160.

The interface circuit 142 is connected to the input/output bus 144. An image display instruction outputted from the CPU 106 on the abovementioned game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program under which a drive signal to be supplied to the liquid crystal display 30 and the liquid crystal display 40 is generated based on the image display instruction from the CPU 106 on the game controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc., and can perform various types of processing for displaying images on the liquid crystal display 30 and the liquid crystal display 40. The video RAM 154 and the ROM 156 are connected to the VDP 152. The video RAM 154 stores image data based on the image display instructions from the CPU 106 on the game controller 100. The image data ROM 156 stores various types of image data containing the abovementioned produced image data. Furthermore, the driving circuit 158 for outputting a driving signal for driving the liquid crystal display 30 and the liquid crystal display 40 is connected to the VDP 152.

By reading and executing the display control program stored in the ROM 148, the CPU 146 instructs the video RAM 154 to store image data to be displayed on the liquid crystal display 30 and the liquid crystal display 40 in response to the image display instruction from the CPU 106 on the game controller 100. Examples of the image display commands include various types of image display commands including the aforementioned image display commands for visual effects, etc.

The image data ROM 156 stores various types of image data including the aforementioned image data for visual effects, etc.

The touch panel control circuit 160 transmits the signals input via the touch panel 32 provided on the liquid crystal display 30 to the CPU 106 via the input/output bus 144 in the form of an an input signal.

FIG. 6 is a flowchart showing the flow of the processing operation of a basic game of the gaming machine 13, which is executed by the game controller 100 of the gaming machine 13. The routine of FIG. 6 is a unit game.

It should be noted that the gaming machine 13 is activated in advance and the variables used in the CPU 106 on the game controller 100 are initialized to predetermined values, respectively, thereby providing normal operation of the gaming machine 13.

Firstly, the CPU 106 on the game controller 100 determines whether any credits remain, which correspond to the remaining amount of coins inserted by the player (Step S1). More specifically, the CPU 106 reads the amount of credits C stored in the RAM 110 and executes processing according to the amount of credits C. When the amount of credits C equals “0” (NO in Step S1), the CPU 106 terminates the routine without executing any processing, since it cannot start a game. When the amount of credits C is not less than “1” (YES in Step S1), the CPU 106 determines that coins remain as credits, and the CPU 106 moves the processing to Step S2.

In Step S2, the CPU 106 determines whether or not a pushing operation has been applied to the spin bet repeat switch 24. When the switch 24 has been pressed and the CPU 106 receives an operation signal from the switch 24 (YES in Step S2), the CPU 106 moves the processing to Step S13. On the other hand, when the CPU 106 does not receive the operation signal from the switch 24 after a predetermined period of time elapses (NO in Step S2), the CPU 106 determines that the switch 24 has not been pressed and moves the processing to Step S3.

In the following Step S3, the CPU 106 sets the game conditions. More specifically, the CPU 106 determines the number of coins bet in a unit game based on the operation of the bet switch 23. The CPU 106 receives the operation signals generated by the player operating the bet switch 23. Then, the CPU 106 stores the bet amount in a predetermined memory area of the RAM 110 based on the number of times the operation signals have been received. The CPU 106 reads the amount of credits C stored in a predetermined memory area of the RAM 110, and subtracts the abovementioned bet amount from the amount of credits C thus read. Then, the CPU 106 stores the subtracted value in a predetermined memory area of the RAM 110. Subsequently, the CPU 106 moves the processing to Step S4.

In the following Step S4, the CPU 106 determines whether the start switch 25 is ON, and then, waits for the start switch 35 to be operated. Upon the start switch 25 being operated, and accordingly, upon the operation signal being input from the start switch 25 (in a case of “YES” in the determination processing in Step S4), the CPU 106 determines that the start switch 25 has been operated and advances the processing to Step S5.

On the other hand, in Step S13, the CPU 106 determines whether the amount of credits C is at least the total bet number in a previous game. In other words, the CPU 106 determines whether it can start a game in response to a pushing operation applied to the spin repeat bet switch 24. More specifically, when the spin repeat bet switch 24 has been pushed, and the operation signal has been inputted to the CPU 106 from the spin repeat bet switch 24, the CPU 106 reads the credit amount C and the bet amount bet in the previous game, which are stored in RAM 110. Then, the CPU 106 determines whether or not the credit amount C is equal to or greater than the bet amount bet in the previous game based upon the relation between the credit amount C thus read and the bet amounts. The CPU 106 performs processing based upon the determination results. When the CPU 106 determines that the amount of credits C is less than the bet amount in the previous game (NO in Step S13), the CPU 106 terminates the present routine without any processing, since it cannot start a game. On the other hand, in a case where determination has been made that the aforementioned amount of credits C is at least the bet amount bet in the previous game (in a case of “YES” in Step S13), the CPU 106 subtracts the bet amount bet in the previous game from the aforementioned amount of credits C, and stores the subtracted value in a predetermined area of the RAM 110. Subsequently, the CPU 106 moves the processing to Step S5.

In the following Step S5, the CPU 106 performs rearranged symbol determination processing. A specific description is made below regarding the rearranged symbol determination processing.

First, the CPU 106 selects a random number in a range of values from 0 to 65535 for each of the fifteen reels by extracting a random number from the random generator 112. Next, the CPU 106 reads payout rate setting data from the ROM 108 to store thereof in the RAM 110, refers to symbol weighted data corresponding to the payout rate setting data, and determines symbols in the fifteen reels to be rearranged in each of the symbol display areas 81 to 95 based on the fifteen random numbers values thus selected. The CPU 106 determines symbols to be rearranged in the symbol display areas 81 to 95, thereby determining a winning combination. In the present embodiment, in a case where five or more identical symbols are rearranged in the symbol display areas 81 to 95, a winning combination corresponding to the rearranged symbols is achieved.

Upon determining a rearranged symbol, the CPU 106 determines whether at least a predetermined number of identical symbols (four symbols) for providing an award among fifteen symbols to be rearranged are rearranged or not. In a case where at least a predetermined number of identical symbols (four symbols) for providing an award among fifteen symbols to be rearranged are rearranged, the CPU 106 activates a flag indicating provision of an award for generating an award corresponding to the predetermined number of identical symbols (four symbols) for providing an award. The activated flag, which indicates the player has won an award, is stored in a predetermined area of the RAM 110 according to the instruction from the CPU 106. On the other hand, in a case where at least a predetermined number of identical symbols (four symbols) for providing an award among fifteen symbols to be rearranged are not rearranged (a losing combination), the CPU 106 does not activate the flag indicating providing the award. Subsequently, the CPU 106 moves the processing to Step S6.

In the following Step S6, the CPU 106 instructs each of the fifteen video reels to start to rotate.

Upon displaying the image which shows each of the fifteen video reels starting to rotate, the CPU 106 waits for a predetermined period of time to elapse (Step S7). After the predetermined period of time has elapsed (in a case of “YES” in processing of Step S7), the CPU 106 instructs each of the fifteen video reels to stop rotating, thereby rearranging 15 symbols (Step S8). Subsequently, the CPU 106 moves the processing to Step S9.

In the following Step S9, the CPU 106 determines whether the flag indicating that an award is provided, which is stored in a predetermined memory area in the RAM 110, is activated or not by means of the rearranged symbol determination processing in Step S5. In a case where the flag indicating that an award is provided is not activated (NO in the processing of Step S9), the CPU 106 terminates the present routine. On the other hand, in a case where the flag indicating that an award is provided is activated (YES in the processing of Step S9), the CPU 106 advances the processing to Step S10.

In the following Step S10, the CPU 106 determines whether the flag (a bonus flag)indicating switching to a bonus game, which is stored in a predetermined memory area in the RAM 110, is activated or not by the rearranged symbol determination processing in Step S5. More specifically, in a case where the flag indicating switching to a bonus game is activated (YES in the processing of Step S10), the CPU 106 advances the processing to Step S11. On the other hand, in a case where the flag indicating the switch to a bonus game is not activated (NO in the processing of Step S10), the CPU 106 advances the processing to Step S12.

In the following Step S11, the CPU 106 performs bonus game processing. More specifically, the CPU 106 starts a bonus game and performs a predetermined number of the bonus games. Subsequently, the CPU 106 terminates the routine.

In the following Step S12, the CPU 106 pays out the amount of coins corresponding to the number of the rearranged identical symbols which are at least a predetermined number (four symbols). More specifically, the CPU 106 refers to a payout table (not shown) and calculates the amount of coins corresponding to the number of the rearranged identical symbols which are at least a predetermined number (four symbols). The CPU 106 reads the credit amount stored in the aforementioned predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the aforementioned value thus stored on the credit amount display unit 49. The CPU 106 then moves the procedure to step S14.

In the following Step S14, the CPU 106 performs adjacency awarding processing. The adjacency award processing is described with reference to FIG. 7.

Rearrangement processing is described with reference to FIG. 7.

In Step S21 in FIG. 7, the CPU 106 first determines whether a “Mag 7” symbol has been rearranged or not. More specifically, the CPU 106 determines whether there is a “Mag 7” symbol among the symbols rearranged in the symbol display areas 81 to 95. In the case of a YES determination, the CPU 106 advances the processing to Step S22. In the case of a NO determination, the CPU 106 advances the processing to Step S23.

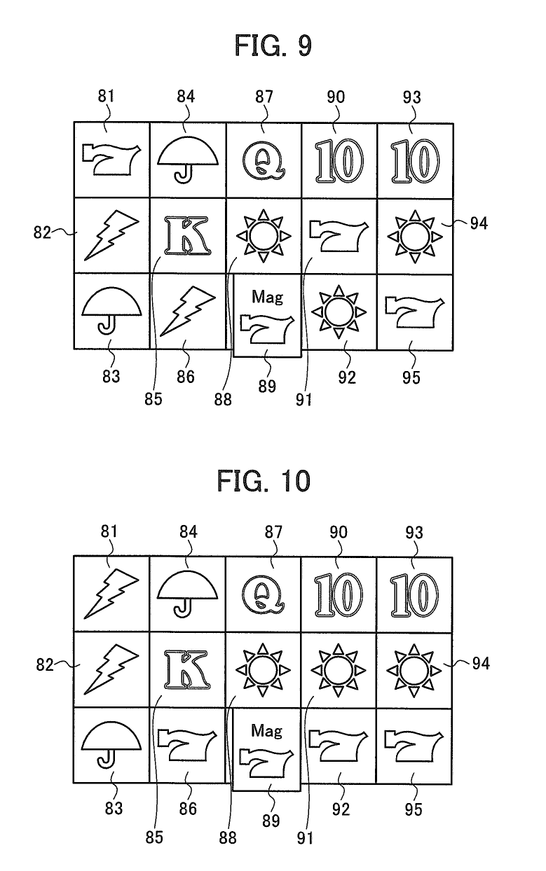

In Step S22, the CPU 106 performs symbol rearrangement again. This rearrangement processing is described with reference to FIGS. 9 and 10. Then, the CPU 106 advances the processing to Step S23.

In Step S23, the CPU 106 provides an award corresponding to the number of “7” symbols adjacent consecutively in a vertical or horizontal direction. Upon terminating the processing, the CPU 106 terminates a basic game.

FIG. 8 illustrates that symbols are rearranged in each of the symbol display areas 81 to 95 in Step S8 of FIG. 6. As described above, according to the present embodiment, an award is provided when at least four identical symbols are rearranged. According to FIG. 8, since “7” symbols are rearranged in the symbol display areas 85, 88, 91, and 95, four “7” symbols have been rearranged. Since the “7” symbol is the only symbol that at least four have been rearranged, the symbol targeted for providing an award is the “7” symbol alone.

In addition, according to FIG. 8, since a “Mag 7” symbol has not been rearranged, the CPU 106 performs processing of Step S23 alone without performing processing of Step S22 (rearranging symbols again) in FIG. 7. In addition, according to FIG. 8, since 11711 symbols are rearranged in the symbol display areas 85, 88, and 91, three “7” symbols are arranged adjacent consecutively in the horizontal direction. Thus, the CPU 106 provides an award as an adjacency award corresponding to the number of adjacent “7” symbols (three symbols). In addition, the CPU 106 provides a bigger award for higher numbers of adjacent symbols that have been rearranged.

FIG. 9 shows that symbols are rearranged in each of the symbol display areas 81 to 95 in Step S8 of FIG. 6. According to FIG. 9, since “7” symbols are rearranged in the symbol display areas 81, 89, 91, and 95, four “7” symbols are rearranged. Since the “7” symbol is the only symbol that at least four have been rearranged, the symbol targeted for providing an award is the “7” symbol alone.

In addition, according to FIG. 9, since a “Mag 7” symbol has been rearranged, the CPU 106 performs processing of Step S22 alone (rearranging symbols again) in FIG. 7.

FIG. 10 shows a result of rearranging symbols again. FIG. 10 shows that “7” symbols are rearranged to be consecutively adjacent in the symbol display areas in a horizontal direction including a “Mag 7” symbol. In addition, according to FIG. 10, since “7” symbols are rearranged in the symbol display areas 86, 89, 92, and 95, four “7” symbols are arranged to be consecutively adjacent in a horizontal direction. Thus, the CPU 106 provides an award as an adjacency award corresponding to the number of adjacent “7” symbols (four symbols).

In addition, symbols arranged in symbol display areas 86 and 92 in FIG. 9 are replaced with “7” symbols, respectively, and each of the “7” symbols are rearranged in the symbol display areas 81 and 91.

In this way, when a “Mag 7” symbol is rearranged in a game in which an adjacency award is provided, identical symbols are rearranged again so as to be arranged consecutively adjacent in the horizontal direction. Accordingly, even when “7” symbols are not arranged to be consecutively adjacent upon rearranging symbols, a player can expect an adjacency award due to a “Mag 7” symbol being rearranged, which enables further enjoyment of games.

In addition, upon a player visually recognizing that a “Mag 7” symbol has been rearranged, the player finds that an adjacency award is going to be provided. Therefore, the player can expect a bigger award when a “Mag 7” symbol has been rearranged.

In addition, in a case where a “Mag 7” symbol is determined to be rearranged, the “Mag 7” symbol is set to be rearranged at the end of the rearrangement, which allows the player to have a sense of anticipation longer as to whether a “Mag 7” symbol might be rearranged.

While the embodiment of the gaming machine according to the present invention has been described, it is to be understood that the above description is intended to be illustrative, and not limiting, and any changes in design may be made to specific configurations such as various means. Moreover, it should be understood that the advantages described in association with the embodiments are merely a listing of most preferred advantages, and that the advantages of the present invention are by no means restricted to those described in connection with the embodiments.

For example, although only a “7” symbol is targeted for processing of rearrangment again in the present embodiment, the present invention is not limited thereto. For example, by rearranging a “Mag K” symbol, a “K” symbol can be targeted for processing of rearrangment again. Thus, another symbol may be targeted for processing of rearrangment again.

In addition, in the present embodiment, the maximum number of symbols to be rearranged adjacent consecutively in a horizontal direction is five. However, in a case where more than five symbols needs to be rearranged adjacent consecutively, those symbols may be rearranged to be consecutively adjacent in a vertical direction as well as a horizontal direction.

In addition, although an adjacency award is provided regardless of the number of symbols arranged adjacent consecutively, the present invention is not limited thereto. For example, an adjacency award may be provided only when at least three symbols are rearranged to be consecutively adjacent.

In addition, although adjacency award processing is performed during a basic game in the present embodiment, the present invention is not limited thereto, and may be performed during a bonus game.

In addition, although in the present embodiment, an example applied to a video reel slot machine is explained regarding the present invention, the present embodiment is not limited thereto, and for example, the present invention may be applied to a mechanical reel slot machine.

What is claimed is:

1. A gaming machine comprising:
a display for variably displaying each of a plurality of symbol groups; and
a controller for executing the following operations of:
(a) generating a random number and starting a game;
(b) determining a symbol to be rearranged on the display corresponding to the random number generated;
(c) variably displaying each of the plurality of symbol groups on the display;
(d) rearranging the symbol determined;
(e) providing a first award corresponding to a number of identical type of symbols rearranged in the processing of (d);
(f) determining whether a symbol to which a predetermined image is added is rearranged among the rearranged symbols in the processing of (d);
(g) upon determining that the symbol to which a predetermined image is added is not rearranged in the processing of (f), providing a second award corresponding to the number of the identical type of symbols aligned in consecutive blocks on a single line in a symbol display block in a matrix in the processing of (d);
(h) upon determining that the symbol to which a predetermined image is added is rearranged in the processing of (f), rearranging again the symbols rearranged in the processing of (d) so as to align the symbol to which a predetermined image is added and the identical type of symbols as the symbol to which a predetermined image is added in consecutive blocks on a single line in a symbol display block in a matrix in the processing of (d), and providing a second award corresponding to the number of the symbol to which a predetermined image is added and the identical type of symbols as the symbol to which a predetermined image is added aligned in consecutive blocks.

2. A gaming machine comprising:
a display for variably displaying each of a plurality of symbol groups; and
a controller for executing the following operations of:
(a) generating a random number and starting a game;
(b) determining a symbol to be rearranged on the display corresponding to the random number generated;
(c) variably displaying each of the plurality of symbol groups on the display;
(d) rearranging the symbol determined;
(e) providing a first award corresponding to the number of identical type of symbols rearranged in the processing of (d);
(f) determining whether a special symbol to which a predetermined image is added is rearranged among the symbols rearranged in the processing of (d);
(g) upon determining that the special symbol to which a predetermined image is added is not rearranged in the processing of (f), providing a second award corresponding to a number of the special symbols aligned in consecutive blocks on a single line in a symbol display block in a matrix in the processing of (d);
(h) upon determining that the special symbol to which a predetermined image is added is rearranged in the processing of (f), rearranging again the symbols rearranged in the processing of (d) so as to align the special symbol to which a predetermined image is added and the identical type of special symbols as the special symbol to which a predetermined image is added in consecutive blocks on a single line in symbol display blocks in a matrix in the processing of (d), and providing a second award corresponding to the number of the special symbol to which a predetermined image is added and the identical type of special symbols as the special symbol to which a predetermined image is added lined in consecutive blocks.
